(19) United States
(12) Patent Application Publication
(10) Pub. No.: US 2012/0107527 A1
(43) Pub. Date: May 3, 2012

(54) USE OF POLYMER BLENDS FOR PRODUCING SLIT FILM TAPES

(75) Inventor: Jörg Auffermann, Freinsheim (DE)

(73) Assignee: BASF SE, Ludwigshafen (DE)

(21) Appl. No.: 13/281,931

(22) Filed: Oct. 26, 2011

Related U.S. Application Data
(60) Provisional application No. 61/407,043, filed on Oct. 27, 2010.

(51) Int. Cl. B32B 27/02; C08K 5/1545; C08K 3/26; C08K 3/04; C08K 3/30; C08K 3/22; C08K 3/16; C08K 7/14; C08K 13/02; C08K 13/04; C08K 3/36; B32B 5/02; B32B 1/08; A41G 1/00; D02G 3/22; D03D 25/00; C08L 67/04

(52) U.S. Cl. 428/17; 525/166; 524/513; 524/53; 524/425; 524/421; 524/431; 524/436; 524/424; 524/447; 428/401; 428/35.2; 428/221

(57) ABSTRACT

The present invention relates to the use of polymer blends for producing slit film tapes comprising:
A) 30% to 50% by weight of a biodegradable, aliphatic-aromatic polyester;
B) 50% to 70% by weight of polylactic acid
   and
C) 0% to 2% by weight of a compatibilizer.

The present invention relates to the use of polymer blends for producing biodegradable slit film tapes comprising:
A) 30% to 50% by weight of a biodegradable, aliphatic-aromatic polyester obtainable by condensation of:
   i) 40 to 70 mol %, based on components i to ii, of one or more dicarboxylic acid derivatives or dicarboxylic acids selected from the group consisting of succinic acid, adipic acid, sebacic acid, azelaic acid and brassylic acid;
   ii) 60 to 30 mol %, based on components i to ii, of a terephthalic acid derivative;
   i.98 to 102 mol %, based on components i to ii, of a C₂-C₈-alkylenediol or C₂-C₆-oxyalkylenediol;
   iv) 0.00% to 2% by weight, based on the total weight of components i to iii, of a chain extender and/or crosslinker selected from the group consisting of a di- or polyfunctional isocyanate, isocyanurate, oxazoline, epoxide, carboxylic anhydride and/or an at least trifunctional alcohol or an at least trifunctional carboxylic acid;
   v) 0.00% to 50% by weight, based on the total weight of components i to iv, of an organic filler selected from the group consisting of native or plasticized starch, natural fibers, wood flour and/or of an inorganic filler selected from the group consisting of chalk, precipitated calcium carbonate, graphite, gypsum, conductivity grade carbon black, iron oxide, calcium chloride, dolomite, kaolin, silicon dioxide (quartz), sodium carbonate, titanium dioxide, silicate, wollastonite, mica, montmorillonites, talcum, glass fibers and mineral fibers; and
   vi) 0.00% to 2% by weight, based on the total weight of components i to iv, of at least one stabilizer, nucleator, lubricating and release agent, surfactant, wax, antistat, antifoggant, dye, pigment, UV absorber, UV stabilizer or other plastic additive;
B) 50% to 70% by weight of polylactic acid
and
C) 0% to 2% by weight of a compatibilizer.

Slit film tapes are described in the literature (die Kunststoffe, Kunststoff Handbuch volume 1, Hanser Verlag 1990) as being composed of polyethylene, polypropylene and polyethylene terephthalate in particular. Articles produced therefrom, such as bags, baler twine, woven fabrics such as woven carpet backings, geotextiles or artificial lawn have the disadvantage that they are not biodegradable and, if they end up in the countryside, present an environmental problem.

Biodegradable monofilaments are described in the literature (Biodegradable and sustainable fibres, Woodhead Publishing Limited, 2005). These filaments/fibers lack stiffness and/or strength and hence are unsuitable for many applications.

It is an object of the present invention to provide thin biodegradable slit film tapes having improved mechanical properties, which can subsequently be worked into threads or woven into fabrics.

Surprisingly, the polymer blends mentioned at the beginning provide slit film tapes of high strength and high modulus of elasticity.

Biodegradable slit film tapes are particularly suitably produced using the abovementioned polymer blends which consist of an aliphatic/aromatic (partly aromatic) polyester A and the blending partner B: polylactic acid.

Partly aromatic polyesters based on aliphatic diols and aliphatic/aromatic dicarboxylic acids also comprise polyester derivatives such as polyether esters, polyester amides or polyether ester amides. Suitable partly aromatic polyesters include linear non-chain-extended polyesters (WO 92/09654). Aliphatic/aromatic polyesters formed from butanediol, terephthalic acid and aliphatic C₆-C₁₈-dicarboxylic acids such as adipic acid, suberic acid, azelaic acid, sebacic acid and brassylic acid (described in WO 2006/097353 to 56 for example) are useful blending partners in particular. Preference is given to chain-extended and/or branched partly aromatic polyesters. The latter are known from the above-cited references WO 96/15173 to 15176, 21689 to 21692, 25446, 25448 or WO 98/12242, which are each expressly incorporated herein by reference. Mixtures of different partly aromatic polyesters are similarly suitable.

As mentioned at the beginning, suitable biodegradable, aliphatic-aromatic polyesters A for the present invention process for producing slit film tapes comprise:
i) 40 to 70 mol %, based on components i to ii, of one or more dicarboxylic acid derivatives or dicarboxylic acids selected from the group consisting of succinic acid, adipic acid, sebacic acid, azelaic acid and brassylic acid;
ii) 60 to 30 mol %, based on components i to ii, of a terephthalic acid derivative;
iii) 98 to 102 mol %, based on components i to ii, of a C₂-C₈-alkylenediol or C₂-C₆-oxyalkylenediol;
iv) 0.00% to 2% by weight, based on the total weight of components i to iii, of a chain extender and/or crosslinker selected from the group consisting of a di- or polyfunctional isocyanate, isocyanurate, oxazoline, epoxide, carboxylic anhydride and/or an at least trifunctional alcohol or an at least trifunctional carboxylic acid;
v) 0.00% to 50% by weight, based on the total weight of components i to iv, of an organic filler selected from the group consisting of native or plasticized starch, natural fibers, wood flour and/or of an inorganic filler selected from the group consisting of chalk, precipitated calcium carbonate, graphite, gypsum, conductivity grade carbon black, iron oxide, calcium chloride, dolomite, kaolin, silicon dioxide (quartz), sodium carbonate, titanium dioxide, silicate, wollastonite, mica, montmorillonites, talcum, glass fibers and mineral fibers; and
vi) 0.00% to 2% by weight, based on the total weight of components i to iv, of at least one stabilizer, nucleator, lubricating and release agent, surfactant, wax, antistat, antifoggant, dye, pigment, UV absorber, UV stabilizer or other plastic additive.

Preferably used aliphatic-aromatic polyesters A comprise:
i) 52 to 65 and more particularly 58 mol %, based on components i to ii, of one or more dicarboxylic acid derivatives or dicarboxylic acids selected from the group consisting of succinic acid, azelaic acid, brassylic acid and preferably adipic acid and more preferably sebacic acid;
ii) 48 to 35 and more particularly 42 mol %, based on components i to ii, of a terephthalic acid derivative;
iii) 98 to 102 mol %, based on components i to ii, of 1,4-butanediol; and
iv) 0% to 2% by weight and preferably 0.01% to 2% by weight, based on the total weight of components i to iii, of a chain extender and/or crosslinker selected from the group consisting of a polyfunctional isocyanate, isocyanurate, oxazoline, carboxylic anhydride such as maleic anhydride, epoxide (more particularly an epoxy-containing poly(meth)acrylate) and/or an at least trifunctional alcohol or an at least trifunctional carboxylic acid.

Slit film tapes are suitably produced using more particularly aliphatic-aromatic polyesters having a high proportion of aliphatic dicarboxylic acid in the range from 52 to 65 and more preferably in the range from 52 to 58 mol %. A higher proportion of the aliphatic dicarboxylic acid in the aliphatic-aromatic polyesters makes it possible to realize thinner layers.

Adipic acid is preferably and sebacic acid is more preferably useful as aliphatic dicarboxylic acids. Polyesters comprising sebacic acid have the advantage that they are also available as a renewable raw material and can be pulled into thinner films.

The A polyesters described are synthesized according to the processes described in WO-A 92/09654, WO-A 96/15173 or preferably in WO-A 09/127,555 and WO-A 09/127,556, preferably in a two-stage reaction cascade. First, the dicarboxylic acid derivatives are reacted together with the diol in the presence of a transesterification catalyst to form a prepolyester. This prepolyester generally has a viscosity number (VN) of 50 to 100 mL/g and preferably 60 to 80 mL/g. It is customary to use zinc, aluminum and more particularly titanium catalysts. Titanium catalysts such as tetra(isopropyl)orthotitanate and more particularly tetrabutyl orthotitanate (TBOT) are superior to the tin, antimony, cobalt and lead catalysts frequently used in the literature, tin dioctanoate being an example, because any residual quantities of the catalyst or catalyst descendent which remain in the product are less toxic. This fact is particularly important for biodegradable polyesters, since they can pass directly into the environment via composting.

The A polyesters are subsequently produced in a second step according to the processes described in WO-A 96/15173 and EP-A 488 617. The prepolyester is reacted with chain extenders vib), for example with diisocyanates, or with epoxy-containing polymethacrylates in a chain extension reaction to form a polyester having a VN of 50 to 450 mL/g and preferably 80 to 250 mL/g.

It is customary to use from 0.01% to 2% by weight, preferably from 0.1% to 1.0% by weight and more preferably from 0.1% to 0.3% by weight, based on the total weight of components i to iii, of a crosslinker (iva) and/or chain extender (ivb) selected from the group consisting of a polyfunctional isocyanate, isocyanurate, oxazoline, epoxide, carboxylic anhydride, an at least trifunctional alcohol or an at least trifunctional carboxylic acid. Useful chain extenders ivb include polyfunctional and more particularly difunctional isocyanates, isocyanurates, oxazolines, carboxylic anhydride or epoxides.

Chain extenders and also alcohols or carboxylic acid derivatives having at least three functional groups can also be regarded as crosslinkers. Particularly preferred compounds have three to six functional groups. Examples are tartaric acid, citric acid, malic acid; trimethylolpropane, trimethylolethane; pentaerythritol; polyether triols and glycerol, trimesic acid, trimellitic acid, trimellitic anhydride, pyromellitic acid and pyromellitic dianhydride. Preference is given to polyols such as trimethylolpropane, pentaerythritol and more particularly glycerol. Components iv can be used to construct biodegradable polyesters having structural viscosity. Melt rheology improves; the biodegradable polyesters are easier to process, for example easier to pull into self-supporting films/sheets by melt solidification. Compounds iv have a shear-thinning effect, i.e., viscosity decreases at higher shear rates.

Examples of chain extenders are more particularly described in what follows.

The term “epoxides” is to be understood as meaning particularly epoxy-containing copolymer based on styrene, acrylic ester and/or methacrylic ester. The units which bear epoxy groups are preferably glycidyl(meth)acrylates. Copolymers having a glycidyl methacrylate content of greater than 20%, more preferably greater than 30% and even more preferably greater than 50% by weight of the copolymer will be found particularly advantageous. The epoxy equivalent weight (EEW) in these polymers is preferably in the range from 150 to 3000 and more preferably in the range from 200 to 500 g/equivalent. The weight average molecular weight M_{W} of the polymers is preferably in the range from 2000 to 25 000 and particularly in the range from 3000 to 8000. The number average molecular weight Mₙ of the polymers is preferably in the range from 400 to 6000 and particularly in the range from 1000 to 4000. The polydispersity (Q) is generally between 1.5 and 5. Epoxy-containing copolymers of the abovementioned type are commercially available, for example from BASF Resins B.V. under the Joncryl® ADR brand. Joncryl® ADR 4368 is particularly useful as chain extender.

It is generally sensible to add the crosslinking (at least trifunctional) compounds at an earlier stage of the polymerization.

Useful bifunctional chain extenders include the following compounds:

An aromatic diisocyanate ivb comprises in particular tolylene 2,4-diisocyanate, tolylene 2,6-diisocyanate, 2,2′-diphenylmethane diisocyanate, 2,4′-diphenylmethane diisocyanate, 4,4′-diphenylmethane diisocyanate, naphthylene 1,5-diisocyanate or xylylene diisocyanate. Of these, particular preference is given to 2,2′-, 2,4′- and also 4,4′-diphenylmethane diisocyanates. In general, the latter diisocyanates are used as a mixture. The diisocyanates may also comprise minor amounts, for example up to 5% by weight, based on the total weight, of urethione groups, for example for capping the isocyanate groups.

The term “aliphatic diisocyanate” herein refers particularly to linear or branched alkylene diisocyanates or cycloalkylene diisocyanates having 2 to 20 carbon atoms, preferably 3 to 12 carbon atoms, for example 1,6-hexamethylene diisocyanate, isophorone diisocyanate or methylenebis(4-isocyanatocyclohexane). Particularly preferred aliphatic diisocyanates are isophorone diisocyanate and, in particular, 1,6-hexamethylene diisocyanate.

The preferred isocyanurates include the aliphatic isocyanurates which derive from alkylene diisocyanates or cycloalkylene diisocyanates having 2 to 20 carbon atoms, preferably 3 to 12 carbon atoms, for example isophorone diisocyanate or methylenebis(4-isocyanatocyclohexane). The alkylene diisocyanates here may be either linear or branched. Particular preference is given to isocyanurates based on n-hexamethylene diisocyanate, for example cyclic trimers, pentamers or higher oligomers of 1,6-hexamethylene diisocyanate.

2,2′-Bisoxazolines are generally obtainable via the process from Angew. Chem. Int. Ed., Vol. 11 (1972), pp. 287-288. Particularly preferred bisoxazolines are those in which R¹ is a single bond, a (CH₂)_{z} alkylene group, where z=2, 3 or 4, such as methylene, 1,2-ethanediyl, 1,3-propanediyl, 1,2-propanediyl or a phenylene group. Particularly preferred bisoxazolines are 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)benzene or 1,3-bis(2-oxazolinyl)benzene.

The number average molecular weight (Mn) of the A polyesters is generally in the range from 5000 to 100 000, particularly in the range from 10 000 to 75 000 g/mol, preferably in the range from 15 000 to 38 000 g/mol, their weight average molecular weight (Mw) is generally in the range from 30 000 to 300 000, preferably 60 000 to 200 000 g/mol, and their Mw/Mn ratio is generally in the range from 1 to 6, preferably in the range from 2 to 4. The viscosity number is generally between 50 and 450 g/mL and preferably in the range from 80 to 250 g/mL (measured in 50:50 w/w o-dichlorobenzene/phenol). The melting point is in the range from 85 to 150° C. and preferably in the range from 95 to 140° C.

The aliphatic dicarboxylic acid i is used in 40 to 70 mol % preferably 52 to 65 mol % and more preferably 52 to 58 mol %, based on the acid components i and ii. Sebacic acid, azelaic acid and brassylic acid are obtainable from renewable raw materials, more particularly castor oil.

The terephthalic acid ii is used in 60 to 30 mol % preferably 48 to 35 mol % and more preferably 48 to 42 mol %, based on the acid components i and ii.

Terephthalic acid and aliphatic dicarboxylic acid can be used either as free acid or in the form of ester-forming derivatives. Useful ester-forming derivatives include particularly the di-C₁- to C₆-alkyl esters, such as the dimethyl, diethyl, di-n-propyl, diisopropyl, di-n-butyl, diisobutyl, di-t-butyl, di-n-pentyl, diisopentyl or di-n-hexyl esters. Anhydrides of the dicarboxylic acids can likewise be used.

The dicarboxylic acids or their ester-forming derivatives can be used individually or in the form of a mixture.

1,4-Butanediol is obtainable from renewable raw materials. WO-A 09/024,294 discloses a biotechnological process for production of 1,4-butanediol from different carbohydrates using microorganisms from the class of the Pasteurellaceae.

In general, at the start of the polymerization, the diol (component iii) is adjusted relative to the acids (components i and ii) such that the ratio of diol to diacids be in the range from 1.0:1 to 2.5:1 and preferably in the range from 1.3:1 to 2.2:1. Excess quantities of diol are withdrawn during the polymerization, so that an approximately equimolar ratio becomes established at the end of the polymerization. By “approximately equimolar” is meant a diol/diacids ratio in the range from 0.98:1 to 1.02:1.

The polyesters mentioned may have hydroxyl and/or carboxyl end groups in any desired proportion. The partly aromatic polyesters mentioned can also be subjected to end group modification. For instance, OH end groups can be acid modified by reaction with phthalic acid, phthalic anhydride, trimellitic acid, trimellitic anhydride, pyromellitic acid or pyromellitic anhydride. Preference is given to polyesters having acid numbers of less than 1.5 mg KOH/g.

In a preferred embodiment, from 1% to 80% by weight, based on the total weight of components i to iv, of an organic filler is selected from the group consisting of native or plasticized starch, natural fibers, wood flour and/or of an inorganic filler is selected from the group consisting of chalk, precipitated calcium carbonate graphite, gypsum, conductivity grade carbon black, iron oxide, calcium chloride, dolomite, kaolin, silicon dioxide (quartz), sodium carbonate, titanium dioxide, silicate, wollastonite, mica, montmorillonite, talcum, glass fibers and mineral fibers and added.

Starch and amylose may be native, i.e., non-thermoplasticized, or they may be thermoplasticized with plasticizers such as glycerol or sorbitol for example (EP-A 539 541, EP-A 575 349, EP 652 910).

Examples of natural fibers are cellulose fibers, hemp fibers, sisal, kenaf, jute, flax, abacca, coir fiber or Cordenka fibers.

Preferred fibrous fillers are glass fibers, carbon fibers, aramid fibers, potassium titanate fibers and natural fibers, of which glass fibers in the form of E-glass are particularly preferred. These can be used as rovings or particularly as chopped glass in the commercially available forms. The diameter of these fibers is generally in the range from 3 to 30 μm, preferably in the range from 6 to 20 μm and more preferably in the range from 8 to 15 μm. The fiber length in the compound is generally in the range from 20 μm to 1000 μm, preferably in the range from 180 to 500 μm and more preferably in the range from 200 to 400 μm.

The biodegradable polyesters A may comprise further ingredients which are known to a person skilled in the art but which are not essential to the present invention. Examples are the materials customarily added in plastics technology, such as stabilizers; nucleating agents; lubricating and release agents such as stearates (particularly calcium stearate); plasticizers such as for example citric esters (particularly tributyl acetylcitrate), glyceric esters such as triacetylglycerol or ethylene glycol derivatives, surfactants such as polysorbates, palmitates or laurates, waxes such as for example beeswax or beeswax ester; antistat, UV absorber; UV stabilizer; antifoggant or dyes. The additives are used in concentrations of 0% to 5% by weight and particularly 0.1% to 2% by weight based on the polyesters of the present invention. Plasticizers may be present in the polyesters of the present invention at 0.1% to 10% by weight.

The biodegradable polymer blends of the present invention are produced from the individual components (polyesters A) and polymer B by following known processes (EP 792 309 and U.S. Pat. No. 5,883,199). For example, all the blending partners can be mixed and reacted in one process step in mixing apparatuses known to one skilled in the art, for example kneaders or extruders, at elevated temperatures, for example in the range from 120° C. to 250° C.

Typical polymer blends comprise:
30% to 50% by weight and preferably 35% to 45% by weight of a polyester A, and
50% to 70% by weight and preferably 55% to 65% by weight of polylactic acid, and
0% to 2% by weight and preferably 0.05% to 1% by weight of a compatibilizer C.

It was found that slit film tapes having a polylactic acid fraction of above 75% by weight are less oriented, are limited to a draw ratio below 5 and have low tensile strengths.

By contrast, slit film tapes comprising above 70% by weight of polyester A are generally highly oriented, yet have a low elongation at break.

An optimum is achieved in the abovementioned preferable and more preferable blending ratios. These ranges make it possible for the tensile strength to be adjusted as required for the particular plant use via suitable temperature and/or process management in the drawing operation.

Polylactic acid is useful as biodegradable polyester B. Polylactic acid having the following profile of properties is preferably used:
an ISO 1133 MVR melt volume rate at 190° C. and 2.16 kg of 0.5 to 15—preferably 1 to 9, particularly 2 to 6 ml/10 minutes
a melting point below 180° C.;
a glass transition point Tg above 55° C.
a water content of less than 1000 ppm
a residual monomer content (lactide) of less than 0.3%
a molecular weight of greater than 50 000 daltons.

Preferred polylactic acids are for example Ingeo® 2002 D, 4032 D, 8251 D, 3251 D and more particularly 4042 D and 4043 D polylactic acids from NatureWorks.

Preferred compatibilizers C are carboxylic anhydrides such as maleic anhydride and particularly the above-described epoxy-containing copolymers based on styrene, acrylic ester and/or methacrylic ester. The epoxy-bearing units are preferably glycidyl(meth)acrylates. Epoxy-containing copolymers of the abovementioned type are commercially available, for example from BASF Resins B.V. under the Joncryl® ADR brand. Joncryl® ADR 4368 for example is particularly useful as a compatibilizer.

The polyesters and polymer blends mentioned at the beginning combine high biodegradability with good film and fiber properties.

The “biodegradable” feature shall for the purposes of the present invention be considered satisfied for any one material or composition of matter when this material or composition of matter has a DIN EN 13432 percentage degree of biodegradation equal to at least 90%.

The general effect of biodegradability is that the polyester (blends) decompose within an appropriate and verifiable interval. Degradation may be effected enzymatically, hydrolytically, oxidatively and/or through action of electromagnetic radiation, for example UV radiation, and may be predominantly due to the action of microorganisms such as bacteria, yeasts, fungi and algae. Biodegradability can be quantified, for example, by polyesters being mixed with compost and stored for a certain time. According to DIN EN 13432, for example, CO₂-free air is flowed through ripened compost during composting and the ripened compost subjected to a defined temperature program. Biodegradability here is defined via the ratio of the net CO₂ released by the sample (after deduction of the CO₂ released by the compost without sample) to the maximum amount of CO₂ releasable by the sample (reckoned from the carbon content of the sample), as a percentage degree of biodegradation. Biodegradable polyesters/polyester blends typically show clear signs of degradation, such as fungal growth, cracking and holing, after just a few days of composting.

Other methods of determining biodegradability are described in ASTM D 5338 and ASTM D 6400-4 for example.

The processes tried and tested in the literature will be found useful for producing the slit film tapes. Reference may be made here for example to the “Solutions for tape production” publication by Oerlikon Barmag and to the multi-stage zonal drawing process described by U. Göschel in Acta Polymerica Vol. 40, issue 1, 01.23-31.1989. In this multi-stage zonal drawing process, a first step i) comprises extruding a flat film by the above-described polymer blend, for example in pellet form comprising components A, B and C, being melted in an extruder, optionally mixed and processed by means of a melt pump via a flat film die into a film from 10 to 250 μm in layer thickness. After the flat film has cooled down in a water bath on a chill roll it is slit into tapes in a step ii). In a step iii), the tapes are stretched/drawn (hereinafter in both cases referred to as “drawn”) over an assembly (the so-called zones) of ovens, cold and/or heated godets. Cold drawing and hot drawing can be combined for example. Hot drawing is generally preceded by a zonal heat treatment. To ideally produce slit film tapes of low film thickness, the slit film tapes are led, after slitting and before separating, through a heating device in order that they may be given a heat treatment. This heat treatment preferably takes the form of the slit film tapes being conditioned by hot air. At the same time, a hot-drawing operation can follow via a downstream drawing system. The tapes are drawn as a result of the different speeds of the godets upstream and downstream of the oven. For instance, a draw ratio of 8 is set by arranging for the godets downstream of the oven to run at 8 times the speed of the upstream godets following the slitting of the flat film. In the course of the drawing operation, the polymer chains become oriented. Strength and modulus of elasticity increase substantially in the direction of drawing and decrease perpendicularly to the direction of drawing.

The layer thickness of the tapes after drawing is generally 10-200 tex and preferably in the range from 40 to 110 tex.

The tape width of the tapes after drawing is generally in the range from 0.2 to 4 mm and preferably in the range from 0.5 to 2 mm.

An optionally installed fibrillator can be used to additionally incorporate cuts/slits into the tape. These fibrillated tapes are particularly useful as sewing yarn or baler twine. The tapes are generally wound up by means of rotating spool heads. Specific twisting machines can also be used to further process the tapes into threads.

Customary fields of use for slit film tapes are as baler twine, circular-woven bags, flat-woven fabrics, Big Bags, woven carpet backing, wall covers, geotextiles, agrotextiles or artificial lawn.

The textiles may also be configured as nets or filters. Woven fabrics made from the slit film tapes of the invention are suitable, for example, as coffee filters, inlays for waste traps of dishwashers and sinks. Since the filters or inlays are biodegradable, they can be disposed of and composted together with the organic kitchen waste.

### EXAMPLES

### Feedstocks

The following polyester blends were used to produce slit film tapes:

### Polyester Blend PM1 (Comparator)

The reference material used was a polymer blend PM1 comprising 20% by weight of Ecoflex® F BX 7011 polybutylene terephthalate co-adipate from BASF SE 79.8% by weight of Ingeo® D 4042 polylactic acid from NatureWorks and 0.2% by weight of Joncryl® ADR 4368 CS ethoxylated polymethacrylate from BASF Nederland B.V.

### Polyester Blend PM2

A polymer blend PM2 comprising 40% by weight of Ecoflex® F BX 7011, 59.8% by weight of Ingeo® D 4042 and 0.2% by weight of Joncryl® ADR 4368 CS.

### Polyester Blend PM3 (Comparator)

A polymer blend PM3 comprising 55% by weight of Ecoflex® F BX 7011, 44.8% by weight of Ingeo® D 4042 and 0.2% by weight of Joncryl® ADR 4368 CS.

### Experimental Setup:

1. tape drawing apparatus

The tapes were produced on an Oerlikon Barmag tape drawing apparatus for polyolefins. An apparatus for producing slit film tapes corresponding substantially to the tape drawing apparatus used is described inter alia in the patent documents DE102005049163A1 and DE10241371A1 and also in the “Solutions for tape production” publication from Oerlikon Barmag.

The tape drawing apparatus was equipped as follows:

A. Film extrusion unit
extruder
melt pump
melt filter
flat film die with profiled die lips
temperature-conditioned chill roll for cooling the flat film extruded by the flat film die
   B. film slitter for slitting the film web into a multiplicity of slit film tapes
   B. drawing device consisting of a stretching unit (godets) upstream of the oven, the hot-air oven itself and 4 temperature-conditioned stretching units (godets) downstream of the oven.

The godets are all individually driven. To stretch the slit film tapes, they are temperature-conditioned within the hot-air sector in the oven and stretched to a particular draw ratio by the different speed settings for the stretching units (godets) upstream and downstream of the oven.

C. withdrawal unit
D. winding device equipped with a multiplicity of winding stations each winding one of the tapes to form a package.
2. tape production

As mentioned, the draw ratio, the residence time of tapes within the hot-air sector in the oven, and also the temperature in the hot-air sector and the godets are significant parameters for influencing the strength properties of the drawn tapes. To maintain the stipulated strength properties of the tapes such as breaking strength and elongation at break for a particular linear density (tape thickness), the draw ratio was kept constant in the runs. The mechanical properties were essentially influenced by varying the residence times and/or the oven and godet temperatures.

### Example 1

### Performed with Polymer Blend PM2

| | | | Output | |
|---|---|---|---|---|
| Unit | Temperature | | speed | |
| extruder | 180° C.-210° C. | | 65 | rpm |
| melt pump | 210° | C. | 100 | kg/h (16.5 1/min) |
| sieve | 210° | C. | | |
| die | 210° | C. | | |
| chill roll | 25° | C. | 12.5 | m/min |
| oven | 91° | C. | | |
| godet 1 (before oven) | | | 13.5 | m/min |
| godet 2 (after oven) | | | 91 | m/min |
| godet 3 (heated) | 82° | C. | 90 | m/min |

Film thickness was 160 μm before slitting into tapes and tape width was 22 mm before drawing. After drawing, tape width was 1.0 mm and tape thickness was 52 tex. Draw ratio was 6.7:1. Tape tenacity was 27 cN/tex and elongation at break was 30%.

### Example 2

Example 1 was repeated except that the temperature of the oven and of godet 3 was raised to 100° C. and draw ratio was raised to 7.5:1. The tapes had the same width and thickness as in Example 1 and a tenacity of 28 cN/tex and an elongation at break of 33%. At the same time, shrinkage was down.

### Comparative Example 3

Example 1 was repeated with PM3. Film thickness was 120 μm before slitting into tapes and tape width was 22 mm before drawing. After drawing, tape width was 2.5 mm and tape thickness was 100 tex. Draw ratio was 5:1. Tape tenacity was 31 cN/tex and elongation at break was 20%.

### Comparative Example 4

Comparative Example 3 was repeated with PM1. Film thickness, tape width, tape thickness and draw ratio were identical to Comparative Example 3. Tape tenacity was 23 cN/tex and elongation at break was 26%.

The results show that a PLA content of preferably 50-70% by weight is beneficial to achieve adequate strength properties. A lower PLA content of, for example, 45% (Comparative Example 3) led to reduced elongation at break, while an excessively high PLA content of, for example, 80% (Comparative Example 4) leads to reduced tenacity under the process settings employed here. It further has to be noted that when the PLA content was still higher (80-100% of PLA) the process did not lead to stable extrusion conditions. The film web before slitting or during slitting into tapes led to frequent ruptures of the film web, attributable to excessively brittle film properties.

1-8. (canceled)

9. A slit film tape prepared from a polymer blend comprising:
A) 30% to 50% by weight of a biodegradable, aliphatic-aromatic polyester obtainable by condensation of:
i) 40 to 70 mol %, based on components i to ii, of one or more dicarboxylic acid derivatives or dicarboxylic acids selected from the group consisting of succinic acid, adipic acid, sebacic acid, azelaic acid and brassylic acid;
ii) 60 to 30 mol %, based on components i to ii, of a terephthalic acid derivative;
iii) 98 to 102 mol %, based on components i to ii, of a C₂-C₈-alkylenediol or C₂-C₆-oxyalkylenediol;
iv) 00% to 2% by weight, based on the total weight of components i to iii, of a chain extender and/or crosslinker selected from the group consisting of a di- or polyfunctional isocyanate, isocyanurate, oxazoline, epoxide, carboxylic anhydride and/or an at least trifunctional alcohol or an at least trifunctional carboxylic acid;
v) 0.00% to 50% by weight, based on the total weight of components i to iv, of an organic filler selected from the group consisting of native or plasticized starch, natural fibers, wood flour and/or of an inorganic filler selected from the group consisting of chalk, precipitated calcium carbonate graphite, gypsum, conductivity grade carbon black, iron oxide, calcium chloride, dolomite, kaolin, silicon dioxide (quartz), sodium carbonate, titanium dioxide, silicate, wollastonite, mica, montmorillonites, talcum, glass fibers and mineral fibers; and
vi) 0.00% to 2% by weight, based on the total weight of components i to iv, of at least one stabilizer, nucleator, lubricating and release agent, surfactant, wax, antistat, antifoggant, dye, pigment, UV absorber, UV stabilizer or other plastic additive;
B) 50% to 70% by weight of polylactic acid
and
C) 0% to 2% by weight of a compatibilizer.

10. The slit film tape of claim 9, wherein said components i) and ii) of said polyester A are defined as follows:
i) 52 to 65 mol %, based on said components i to ii, of one or more dicarboxylic acid derivatives or dicarboxylic acids selected from the group consisting of succinic acid, adipic acid, sebacic acid, azelaic acid and brassylic acid;
ii) 48 to 35 mol %, based on said components i to ii, of a terephthalic acid derivative.

11. The slit film tape of claim 9, wherein component i of said polyester A comprises sebacic acid or mixtures of sebacic acid with the other diacids.

12. The slit film tape of claim 9, wherein said slit film tape is prepared from a premixed polymeric mixture of 30% to 50% by weight of component A, 50% to 70% by weight of component B, and 0.05% to 1% by weight, based on components A and B, of a compatibilizer C.

13. The slit film tape of claim 9, wherein said compatibilizer C comprises from 0.05% to 1% by weight of an epoxy-containing copolymer based on styrene, acrylic ester and/or methacrylic ester.

14. The slit film tape of claim 9, wherein a layer thickness of the tapes after drawing of 40 to 110 tex is set.

15. The slit film tape of claim 9, wherein a tape width of the tapes after drawing of 0.5 to 2 mm is set.

16. Baler twine, circular-woven bags, flat-woven fabrics, Big Bags, carpet backing, geotextiles, agrotextiles, filters or inlays for waste traps, or artificial lawn produced from the slit film tape of claim 9.
